(19) United States
(12) Patent Application Publication
(10) Pub. No.: US 2009/0124943 A1
(43) Pub. Date: May 14, 2009

(54) Massage device

(76) Inventors: Shiuan-Ruey Hwang, Fanlu Siang (TW); Yi-iong Lee, Fanlu Siang (TW)

Correspondence Address: Hershkovitz & Associates, LLC, 2845 Duke Street, Alexandria, VA, 22314, US

(21) Appl. No.: 11/979,788

(22) Filed: Nov. 8, 2007

(51) Int. Cl. A61H 1/00

(52) U.S. Cl. 601/137

(57) ABSTRACT

A massage device has a head and a handle. The head has an open-end, a domed end, a buffer and a through hole defined through the domed end. The open-end has an outer edge and the buffer is mounted around the outer edge. The handle is connected to the head. The massage device is hit against a person's body, causing a sound wave to be produced with associated health benefits.

### BACKGROUND OF THE INVENTION

1. Field of the Invention

The present invention relates to a massage devices especially to a massager device that is capable of providing sound waves.

2. Description of the Related Art

A conventional massage device allows people to massage themselves and comprises a massage pad and a handle. The massage pad has multiple bulges formed on and protruding from the massage pad. The handle has a distal end and a flexible connecting rod. The connecting rod connects the distal end of the handle to the massage pad. The massage device is rubbed against the body to provide a massage effect.

Another conventional massage apparatus has a handle and multiple long and thin sticks. The sticks have proximal ends that are bundles together and mounted onto the handle. The massage apparatus is used to hit someone's body.

The aforementioned conventional massage device and apparatus are hard to control and may cause pain. Therefore, the conventional massage device and apparatus cannot be used on injuries or on the elderly. Sound waves have been used in a variety of medical treatments, including, some lung cancers in Germany where the growth rate of the tumor cells are reduced, and a conventional treating method using sound-waves to treat flu, headache, adynamia in the nervous system, arrhythmia, high blood pressure, chronic iron-deficiency anemia and digestive system related diseases. Some hospitals use sound waves in physical therapy.

### SUMMARY OF THE INVENTION

The objective of the present invention is to provide a massage device that produces sound waves. The massage device can be used for massage to further improve health.

To achieve the objective, the massage device in accordance with the present invention comprises a head and a handle. The head has an open-end, a domed end, a buffer and a through hole defined through the domed end. The open-end has an outer edge and the buffer is mounted around the outer edge. The handle is connected to the head. The massage device is hit against a person's body, causing a sound wave to be produced with associated health benefits.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a massage device in accordance with the present invention;

FIG. 2 is a partially exploded perspective view of the massage device in FIG. 1;

FIG. 3 is a enlarged cross sectional side view of the massage device in FIG. 1; and

FIG. 4 is an operational view of the massage device in FIG. 1.

### DETAILED DESCRIPTION OF THE PREFERRED EMBODIMENTS

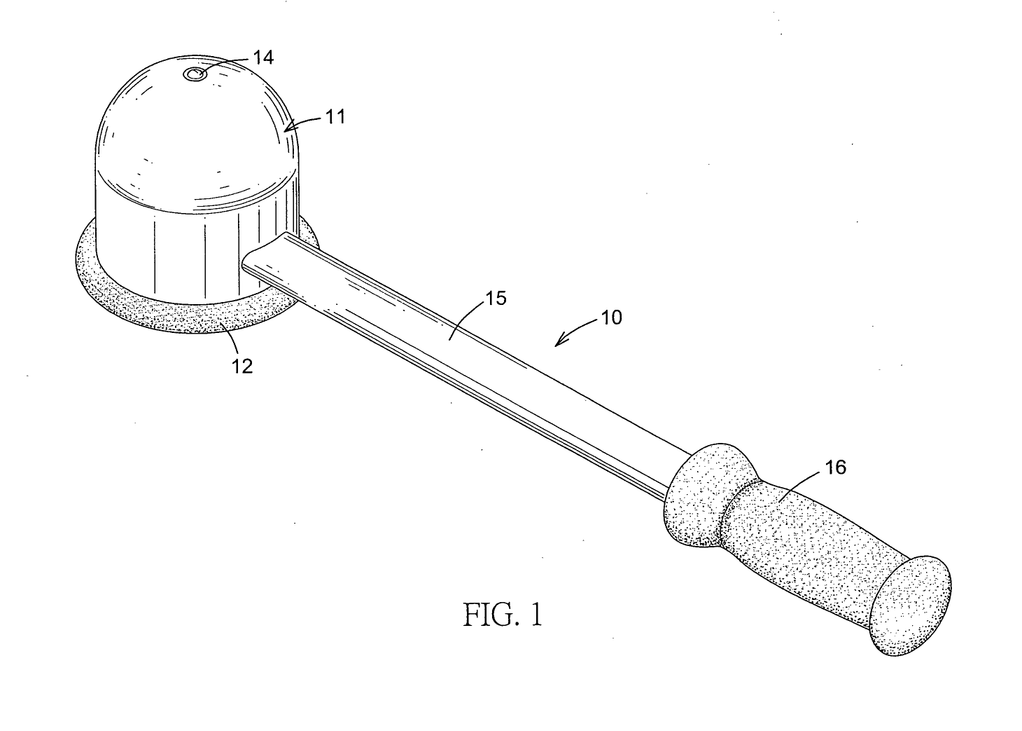

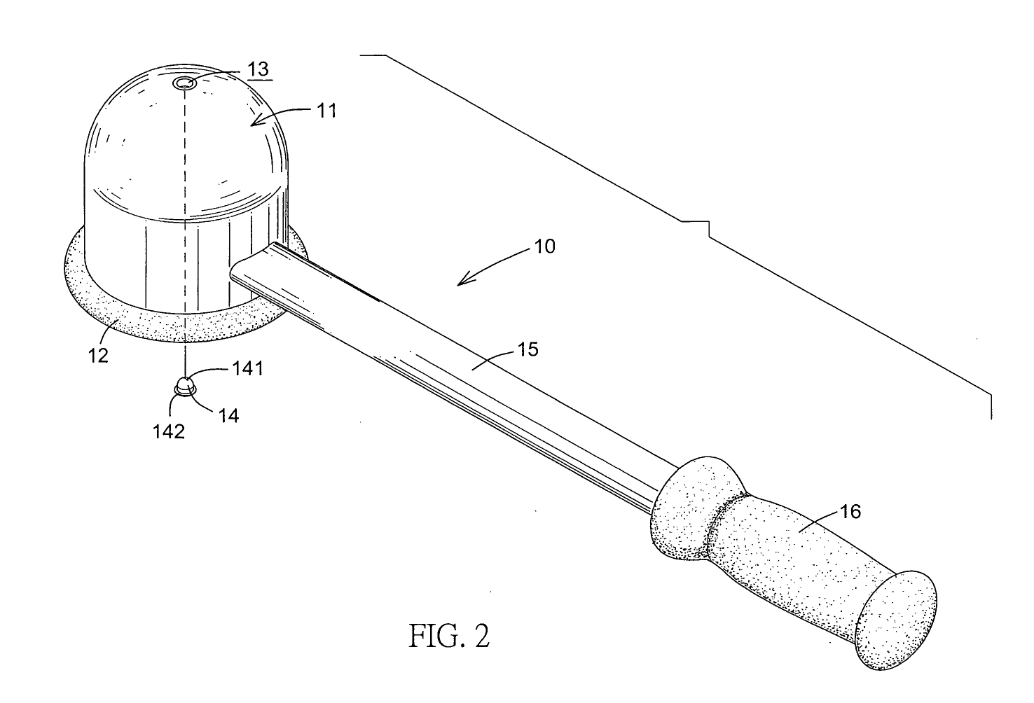

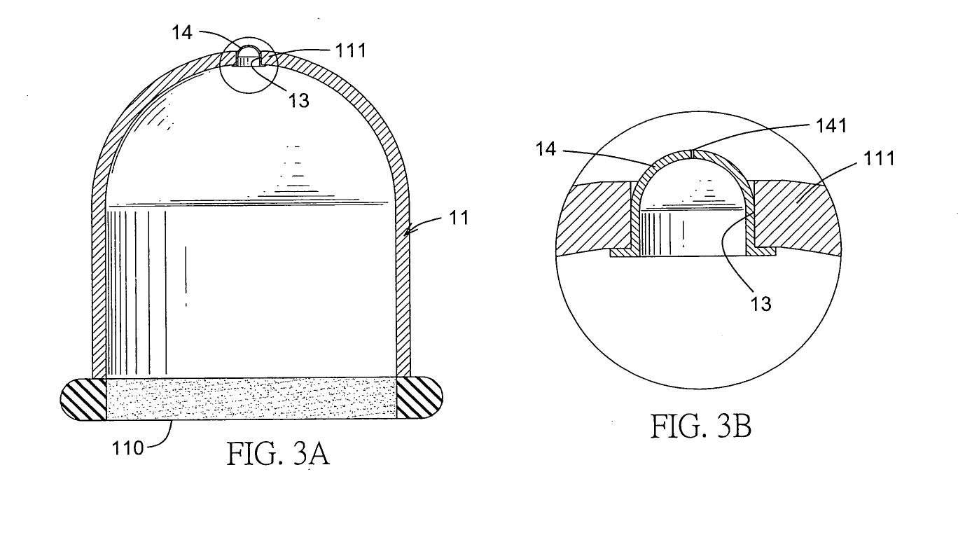

With reference to FIGS. 1 to 3, a massage device (10) in accordance with the present invention has a head (11) and a handle (15).

The head (11) has an open-end (110), a domed end (111), a buffer (12), a through hole (13) and a vacuum-breaker (14). The open-end (110) is formed in the head (11) and has an outer edge. The buffer (12) is mounted around the outer edge of the open-end (110) of the head (11). The buffer (12) is resilient and may be foam or rubber.

The through hole (13) is formed through the domed end (111) of the head (11). A vacuum-breaker (14) is mounted in the through hole (13) and has an open-end, a closed end, a lip (142) and may further comprise a vent (141). The vacuum-breaker (14) may be rubber and U-shaped in cross section. The lip (142) is formed on and protrudes around the open-end of the vacuum-breaker (14) and abuts the through hole (13) of the head (1 1).The vent (141) is formed through the closed end of the vacuum-breaker (14). At neutral air pressure, the vent (14) is closed. When air pressure inside the head (11) is greater than or less than air pressure outside the head (11), the vent (14) opens.

Therefore, when the head (11) is hit against a body, the buffer (12) will form a temporary seal and change the air pressure in the head (11), causing a flow of air through the vacuum-breaker (12) and producing a sound wave with the associated health benefits.

The handle (15) is flexible and connected to the head (11) and has a length, a proximal end and an optional grip (16). The length of the handle (15) is related to the frequency of sound waves produced by the massage device (10).

The handle (15) may be flat or round in cross-section, may be two flat pieces of metal or telescopic. The resilient member may be a spring and is mounted in the handle (15).

The grip (16) is mounted on the distal end of the handle (15).

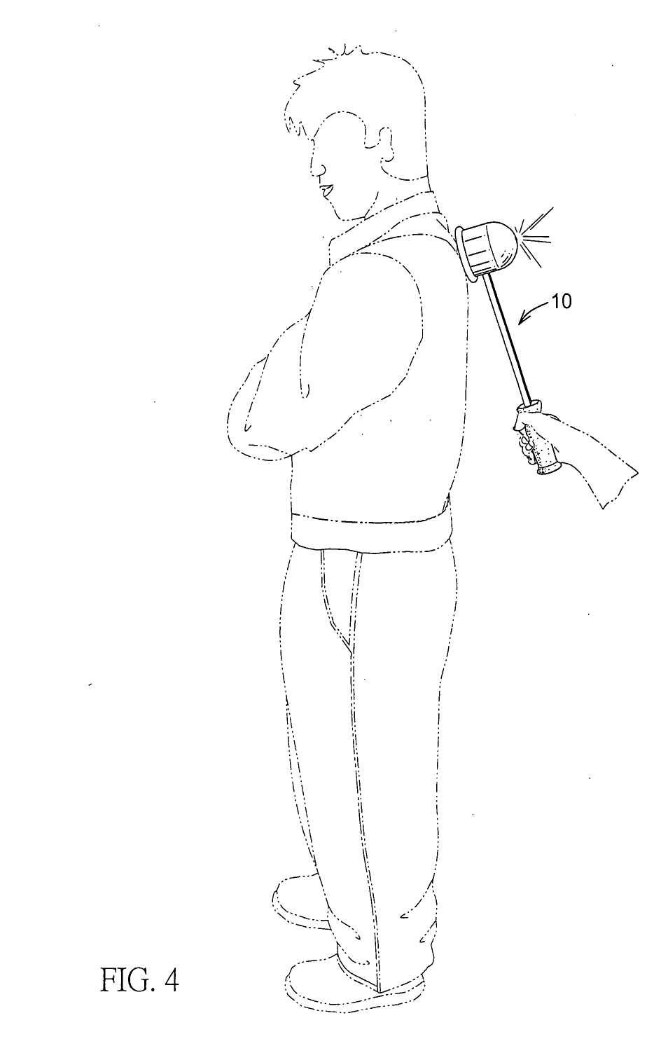

With further reference to FIG. 4, the massage device (10) can be used on or by an injured, elderly or young person in order to promote burping or excrete phlegm. Because the handle (15) is flexible and adjustable, a person can use the massage device (10) alone.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A massage device, comprising:
a head having
an open-end being formed in the head and having an outer edge;
a domed end;
a buffer being mounted around the outer edge of the open-end of the head;
a through hole being formed through the domed end of the head; and
a vacuum-breaker being mounted in the through hole and having
an open-end;
a closed end; and
a lip being formed on and protruding around the open end of the vacuum-breaker and abutting the through hole of the head; and
a handle being flexible and connected to the head and having a length and a proximal end.

2. The massage device as claim in claim 1, wherein the buffer is resilient.

3. The massage device as claim in claim 2, wherein the buffer is foam.

4. The massage device as claim in claim 2, wherein the buffer is rubber.

5. The massage device as claim in claim 1, wherein the handle has a grip mounted on the proximal end.

6. The massage device as claim in claim 1, wherein the handle is telescopic.

7. The massage device as claim in claim 1, wherein the vacuum-breaker is U-shaped in cross section and further comprises a vent being formed through the closed end of the vacuum-breaker.

8. The massage device as claim in claim 2, wherein the vacuum-breaker is U-shaped in cross section and further comprises a vent being formed through the closed end of the vacuum-breaker.

9. The massage device as claim in claim 3, wherein the vacuum-breaker is U-shaped in cross section and further comprises a vent being formed through the closed end of the vacuum-breaker.

10. The massage device as claim in claim 4, wherein the vacuum-breaker is U-shaped in cross section and further comprises a vent being formed through the closed end of the vacuum-breaker.

11. The massage device as claim in claim 5, wherein the vacuum-breaker is U-shaped in cross section and further comprises a vent being formed through the closed end of the vacuum-breaker.

12. The massage device as claim in claim 6, wherein the vacuum-breaker is U-shaped in cross section and further comprises a vent being formed through the closed end of the vacuum-breaker.
